(19) United States
(12) Patent Application Publication
(10) Pub. No.: US 2026/0371242 A1
(43) Pub. Date: Nov. 19, 2026

(54) METHOD PERFORMED BY USER EQUIPMENT, METHOD PERFORMED BY ACCESS NETWORK NODE, USER EQUIPMENT, AND ACCESS NETWORK NODE

(71) Applicant: NEC Corporation, Tokyo (JP)

(72) Inventor: Ayesha IJAZ, Guildford (GB)

(73) Assignee: NEC Corporation, Tokyo (JP)

(21) Appl. No.: 19/139,429

(22) PCT Filed: Dec. 18, 2023
(86) PCT No.: PCT/JP2023/045215

§ 371 Date: Jun. 16, 2025

(30) Foreign Application Priority Data
Dec. 22, 2022 (GB) 2219592.9

(51) Int. Cl. H04W 52/02; H04W 74/0833; H04W 76/28

(52) U.S. Cl. CPC H04W 52/0219; H04W 74/0833; H04W 76/28

(57) ABSTRACT

A method performed by a user equipment, UE, is provided. The method includes: transmitting, to an access network node, a wakeup indication for requesting the access network node to trigger a desired behaviour of at least one of the access network node, at least one cell of the access network node, or at least one transmission/reception point, TRP, coupled to the access network node; and communicating with the access network node based on the desired behaviour. Here, the wakeup indication is transmitted using at least one of: a medium access control, MAC, transmission, a dedicated physical random access channel, PRACH, preamble, or a dedicated scheduling request.

### TECHNICAL FIELD

The present disclosure relates to a communication system. The present disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The present disclosure has particular, although not necessarily exclusive, relevance to wakeup signals and discontinuous reception.

### BACKGROUND ART

Recent developments of the 3GPP standards are referred to as the Long-Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node or base station to refer to any such access nodes.

There is a need for improved wireless communication networks having improved energy efficiency. A reduction in the amount of energy needed to operate a communication network beneficially reduces the environmental impact of operating the system, and also reduces the operational costs. Moreover, for battery-powered devices (for example, a UE) reduced power consumption extends the battery life of the device.

One method of achieving a more efficient communication network is to reduce the energy requirements of the radio access network part of the system. The energy consumption of the radio access network includes a dynamic part that is associated with data transmission and reception, and a static part that associated with operations of the radio access devices that are performed even when there is no ongoing data transmission or reception. The static part may include, for example, the power required to operate a UE in a mode in which the UE is able receive and decode a physical downlink control channel (PDCCH) transmitted by a base station. Energy saving modes may be configured for one or more devices in the system (e.g. a UE). For example, a UE may be configured to operate in an energy saving mode (which may also be referred to as a sleep mode) in which the UE performs a reduced number of transmissions, or in which the UE is configured not to attempt to transmit or receive signals during a particular time period.

However, when implementing energy saving methods in a radio access network there are a number of considerations that need to be taken into account. For example, the impact on the performance of the system (e.g. latency) of the energy saving methods is important to consider. Efficient configuration of the activation and deactivation (e.g. wake-up) of energy saving modes that ensures that devices are still able to communicate reliably and with acceptable latency are needed.

More generally, there is a need for more efficient and reliable methods and apparatus for increasing the energy efficiency of wireless communication systems.

### CITATION LIST

### Non Patent Literature

NPL 1: ‘NGMN 5G White Paper’ V1.0

### SUMMARY OF INVENTION

### Technical Problem

The present disclosure aims to provide apparatus and methods that at least partially address the above needs and/or issues.

### Solution to Problem

In a first aspect, the present disclosure provides a method performed by a user equipment, UE, the method comprising: transmitting, to an access network node, a wakeup indication for requesting the access network node to trigger a desired behaviour of at least one of the access network node, at least one cell of the access network node, or at least one transmission/reception point, TRP, coupled to the access network node; and communicating with the access network node based on the desired behaviour, wherein the wakeup indication is transmitted using at least one of: a medium access control, MAC, transmission, a dedicated physical random access channel, PRACH, preamble, or a dedicated scheduling request.

The wakeup indication may be transmitted based on at least one of: an energy saving technique; or whether the UE is synchronised with the access network node.

The desired behaviour may include at least one of: transmission or reception of a specific signal or channel; a change of transmission or reception periodicity of a signal or channel; or transition to a legacy behaviour of the access network node from an energy saving behaviour.

The wakeup indication may be included in a field of a MAC control element, CE, and another wakeup indication may be included in at least one of: another field of the MAC CE; or the field of another MAC CE.

The method may further comprise: receiving, from the access network node, configuration information for transmitting the wakeup indication; and transmitting the wakeup indication based on the configuration information.

The configuration information may indicate a resource to use to transmit the wakeup indication to the access network node, and the resource may be based on a resource used for another transmission or reception of a signal or channel.

The resource may be relative to another resource for the another transmission or reception.

The configuration information may indicate an offset relative to the another resource for the another transmission or reception.

The offset may be at least one of: a fixed offset, a semi-static offset, or a dynamic offset.

The another resource may be for: a wakeup signal; a paging occasion; a UE discontinuous reception, DRX, on duration; or a Configured Grant-Physical Uplink Shared Channel (CG-PUSCH).

The configuration information may be transmitted in at least one of: a cell-specific manner; a UE-specific manner; or a transmission associated with a group of UEs.

The configuration information may be transmitted in at least one of: system information; a Layer 1 signal; a Layer 2 signal; or a Layer 3 signal.

The configuration information indicates at least one of: a length or duration of a resource to use for transmitting the wakeup indication; or a starting position in a time and/or frequency domain to use for transmitting the wakeup indication.

The configuration information may be transmitted with configuration information for a discontinuous reception or discontinuous transmission procedure performed by the UE.

The method may further comprise: performing a feedback procedure for the desired behaviour.

In a second aspect, the present disclosure provides a method performed by an access network node, the method comprising: receiving, from a user equipment, UE, a wakeup indication for requesting the access network node to trigger a desired behaviour of at least one of the access network node, at least one cell of the access network node, or at least one transmission/reception point, TRP, coupled to the access network node; and communicating with the UE based on the desired behaviour, wherein the wakeup indication is received using at least one of: a medium access control, MAC, transmission; a dedicated physical random access channel, PRACH, preamble; or a dedicated scheduling request.

In a third aspect, the present disclosure provides a user equipment, UE, comprising:
means for transmitting, to an access network node, a wakeup indication for requesting the access network node to perform a desired behaviour of at least one of the access network node, at least one cell of the access network node, or at least one transmission/reception point, TRP, coupled to the access network node; and means for communicating with the access network node based on the desired behaviour, wherein the UE is configured to transmit the wakeup indication using at least one of: a medium access control, MAC, transmission; a dedicated physical random access channel, PRACH, preamble; or a dedicated scheduling request.

In a fourth aspect, the present disclosure provides an access network node comprising: means for receiving, from a user equipment, UE, a wakeup indication for requesting the access network node to trigger a desired behaviour of at least one of the access network node, at least one cell of the access network node, or at least one transmission/reception point, TRP, coupled to the access network node; and means communicating with the UE based on the desired behaviour, wherein the access network node is configured to receive the wakeup indication using at least one of: a medium access control, MAC, transmission; a dedicated physical random access channel, PRACH, preamble; or a dedicated scheduling request.

### BRIEF DESCRIPTION OF DRAWINGS

Embodiments of the present disclosure will now be described, by way of example, with reference to the accompanying drawings.

FIG. 1 schematically illustrates a mobile (‘cellular’ or ‘wireless’) communication system.

FIG. 2 illustrates a typical frame structure that may be used in the communication system of FIG. 1.

FIG. 3 illustrates an example of a DRX cycle.

FIG. 4 illustrates a method in which a MAC CE comprises a WUS.

FIG. 5 illustrates a method in which a UE transmits a PRACH preamble corresponding to a WUS.

FIG. 6 illustrates a method in which a UE transmits a scheduling request corresponding to a WUS.

FIG. 7 illustrates a method of providing a configuration for uplink WUS to a UE.

FIG. 8 is a schematic block diagram illustrating the main components of a UE for the communication system of FIG. 1.

FIG. 9 is a schematic block diagram illustrating the main components of a base station for the communication system of FIG. 1.

### DESCRIPTION OF EXAMPLE EMBODIMENTS

### Overview

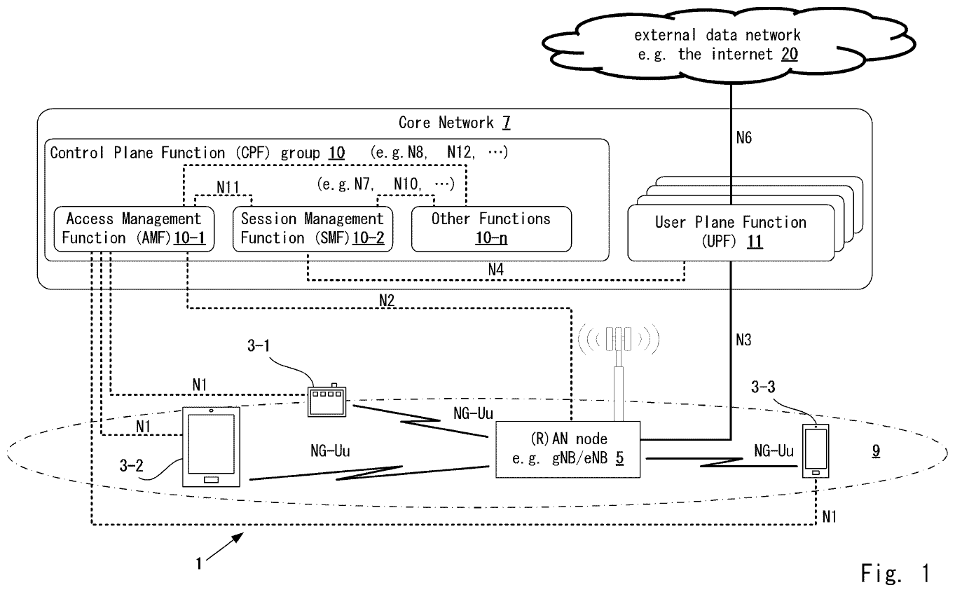

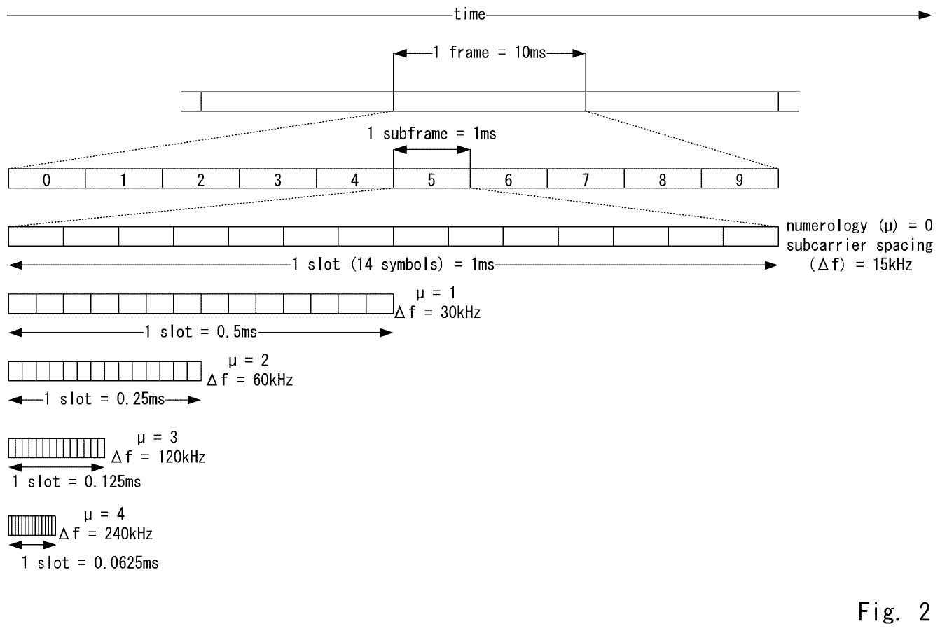

An exemplary communication system will now be described in general terms, by way of example only, with reference to FIGS. 1 and 2.

FIG. 1 schematically illustrates a mobile (‘cellular’ or ‘wireless’) communication system 1 to which embodiments of the present disclosure are applicable.

In the communication system 1 user equipment (UEs) 3-1, 3-2, 3-3 (e.g. mobile telephones and/or other mobile devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 1 for illustration purposes, the system, when implemented, will typically include other base stations 5 and UEs 3.

Each base station 5 controls the one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

The one or more UPFs 11 are connected to an external data network (e.g. an IP network such as the internet) via reference point N6 for communication of the user data.

The AMF 10-1 performs mobility management related functions, maintains the non-NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection. The UE 3 may receive a Synchronisation Signal Block (SSB), and the UE 3 may assume that reception occasions of a PBCH, primary synchronisation signal (PSS) and secondary synchronisation signal (SSS) are in consecutive symbols and form a SS/PBCH block. The base station 5 may transmit a number of synchronisation signal (SS) blocks corresponding to different DL beams. The total number of SS blocks may be confined, for example, within a 5 ms duration as an SS burst. The periodicity of the SSB transmissions may be indicated to the UE using any suitable signalling (e.g. per serving cell using ssb-periodicityServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-PositionsInBurst).

The DL physical signals may include, for example, reference signals (RSs) and synchronisation signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random access channel (PRACH). The UL physical signals may include, for example, demodulation reference signals (DMRS) for a UL control/data signal, and/or sounding reference signals (SRS) used for UL channel measurement.

### Frame Structure

Referring to FIG. 2, which illustrates a typical frame structure that may be used in the communication system 1, the base station 5 and UEs 3 of the communication system 1 communicate with one another using resources that are organized, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of u can, in effect, be derived from μ=0 by scaling up in powers of 2 (i.e. SCS=15×2u kHz). The relationship between the parameter, μ, and SCS (Δf) is as shown in Table 1:

TABLE 1
5G Numerology

| | | Number of slots | |
|---|---|---|---|
| μ | Δf = 2^{μ} · 15[kHz] | per subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### System Information and SIB

It will be appreciated that transmissions in a cell 9 of a base station 5 may include one or more broadcast transmissions and one or more unicast transmissions for reception by a UE 3. System information (SI) transmitted in a cell may include ‘minimum SI’ (MSI) and ‘other SI’ (OSI). The OSI may be broadcast on-demand, for example using a downlink shared channel (DL-SCH).

The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell selection, may include information for enabling the UE 3 to complete a cell reselection procedure, or for enabling the UE 3 to receive one or more paging messages transmitted in a cell. SI may be broadcast using a Master Information Block (MIB) and one or more System Information Blocks (SIB).

The MSI comprises the MIB and system information block 1 (SIB1). The MIB includes information for use by a UE 3 to receive SIB1, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIB (e.g. SIB2 to SIB9) may be transmitting using one or more other suitable RRC transmissions. The MIB and SIB1 may provide the UE 3 with an indication of scheduling information for receiving and decoding the other SIB, such as SIB2 to SIB9, and may provide information for use by the UE 3 to receive one or more paging messages. The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIB1 to SIB9 are described in more detail, for example, in 3GPP TS 38.331. For example, SIB2 provides information for intra-frequency, inter-frequency and inter-system cell reselection, SIB3 provides cell-specific information for intra-frequency cell reselection, and SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialisation) and local time.

SIB may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIB1 may be transmitted with a periodicity of 160 ms and a variable transmission repetition periodicity within 160 ms (e.g. 20 ms). SIB1 can be used to indicate to a UE 3 which SIB are transmitted periodically and which SIB are available on-demand in response to a request from the UE 3. A UE 3 may be configured to request on-demand SIB using MSG1 (random access preamble (RA)), which may be referred to as a MSG1-based on-demand SI request, or MSG3 (RRC Connection Request), which may be referred to as a MSG3-based on-demand SI request.

A physical broadcast channel (PBCH) can be used to broadcast the MIB. The base station 5 may transmit the PBCH with synchronisation signals (SS) (e.g. primary synchronisation signal (PSS) and secondary synchronisation signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block consists of 240 contiguous subcarriers. When the UE 3 is in an RRC connected mode, the base station 5 may provide the UE 3 with an indication of resources used for the SS/PBCH, for example using dedicated signalling (e.g. for an anchor NES cell or a non-anchor NES cell). SIB1 may be transmitted using a physical downlink shared channel (PDSCH). The OSI may be similarly transmitted, for example, using a PDSCH.

When one or more beamformed transmissions are transmitted in a cell provided by the base station 5, some of the SI (e.g. some of the SIB) may only be transmitted using particular beams, or using a particular transmission/reception point (TRP).

### Discontinuous Reception

A device (e.g. a UE 3) may be configured to operate using a discontinuous reception (DRX) method. In a DRX method, the UE 3 is configured with a DRX cycle that includes periods in which the UE 3 is configured for receiving transmissions, and periods in which the UE 3 is not configured for receiving transmissions (e.g. transmissions from a base station 5). The period in which the UE 3 is not configured for receiving transmissions may be a period in which physical layer processing is turned off. Advantageously, the energy consumption of the UE 3 is reduced in the periods in which the UE 3 is not configured for receiving transmissions.

The UE 3 may be provided with a configuration for the DRX by the network (e.g. by or via the base station 5). A DRX configuration provided to the UE 3 (for example, using a DRX configuration information element (IE) included in a transmission from the base station 5 to the UE 3) may include an indication of a time period for which the UE 3 is to be configured in a state in which the UE 3 does not receive and decode downlink transmissions, and an indication of a time period for which the UE 3 is to be configured for receiving downlink transmissions (e.g. a multicast or unicast transmission from the base station 5). The DRX configuration may include a time offset for the DRX cycle, which may be useful for controlling the relative timing of the DRX cycles of different UEs 3 (e.g. to synchronise or offset the DRX cycles). The DRX configuration may include an indication of a period in which the UE is to remain configured for receiving transmissions following the reception of a PDCCH.

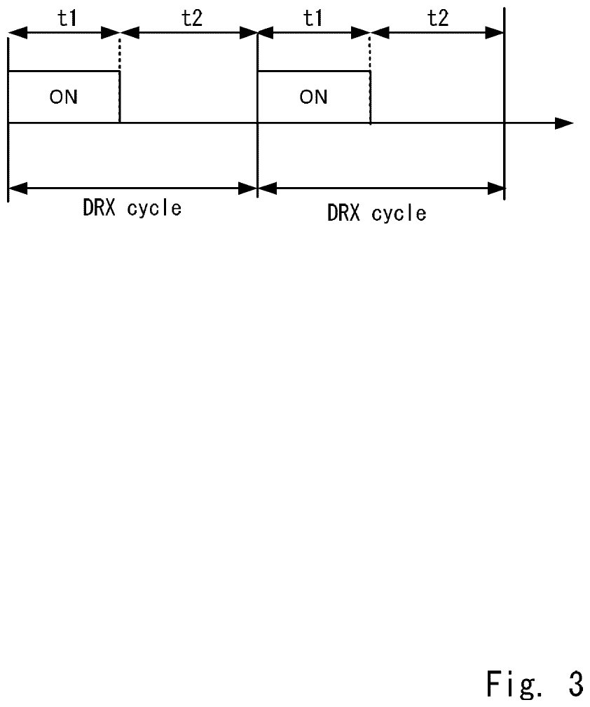

The period in which the UE 3 is configured for receiving transmissions during the DRX cycle may be referred to as an ‘ON’ period or ‘DRX active time’, and the period in which the UE 3 is not configured for receiving transmissions may be referred to as an ‘OFF’ period, ‘sleep period’, or ‘DRX inactive time’. An illustration of an ON period having a duration t1, and an OFF period having a duration t2, within a repeating DRX cycle is illustrated in FIG. 3.

DRX may be configured per UE 3 by the network (e.g. via any suitable signalling from the base station 5). For example, the timing and/or duration of the ON periods in the DRX cycle may be different for different UEs 3. During the OFF periods, the UE 3 may be configured to not monitor a PDCCH, but may initiate an uplink transmission based on configured resources (for example, using a PUCCH, a random access channel (RACH), scheduling request (SR) or a configured grant PUSCH (CG-PUSCH)). During an OFF period, the system may be configured for no transmission/reception between the UE 3 and the base station 5 in a corresponding cell. The base station 5 may nevertheless be configured for reduced or limited transmission/reception in the cell during the OFF period of the DRX cycle. For example, the base station 5 may be configured not to transmit only a subset of periodic signals or channels, such as common channels/signals or UE-specific channels/signals that would normally be transmitted in the cell.

DRX may be used when the UE 3 is in an RRC idle mode or when the UE 3 is in an RRC connected mode. For example, DRX may be used when the UE 3 is in an RRC idle mode to control the monitoring of paging messages transmitted by the base station 5. This advantageously prevents the UE 3 from monitoring all of the PDCCH transmission opportunities, thereby reducing the energy usage of the UE 3. Similarly, DRX may be used when the UE 3 is in the RRC connected state to reduce the energy usage of the UE 3, for example by configuring periods in which the UE 3 is not required to monitor a PDCCH.

Within a DRX cycle, when the UE 3 is in an RRC connected state, the UE 3 periodically monitors the PDCCH during the ON periods, and does not monitor PDCCH outside of the ON periods (i.e. in the DRX inactive periods), thereby beneficially reducing the power consumption of the UE 3.

Outside of the DRX active periods, the base station 5 may be configured to reduce (e.g., temporarily increase the periodicity) or disable transmissions and channels such as SSB/SI/paging/RACH to reduce energy consumption at the base station 5. As will be described in more detail later, when the UE 3 determines to transmit/receive DL/UL signals and channels outside of the DRX active period, an uplink WUS can be used to request transmitting/receiving the corresponding DL/UL signals and channels.

A DRX configuration may include a long DRX cycle in which the time between the ON periods is relatively large (t2 shown in FIG. 3 is relatively large), and a short DRX cycle in which the time between the ON periods is relatively small (t2 shown in FIG. 3 is relatively small). Whilst the long DRX cycle improves the energy efficiency of the system (because the overall percentage of time in which the UE 3 is in the ON state is smaller), latency of communications may be increased because the base station 5 cannot communicate with the UE 3 via downlink transmissions when the UE 3 is in the sleep state (the DRX inactive state). When the UE 3 is configured to use DRX after a period of inactivity following a data transfer, the UE 3 may be configured to initially use the short DRX cycle configuration (alternatively, the UE 3 may be controlled to begin DRX using the short DRX configuration, following the data transfer, based on signalling from the base station 5 such as a medium access control (MAC) control element (CE), or any other suitable signalling that indicates that the UE 3 should begin DRX). After a further period of time (which may be referred to as the Short DRX Cycle timer) the UE 3 may then operate using the long DRX cycle configuration. The short and long DRX configurations may be indicated to the UE 3, for example, using any suitable signalling from the base station 5 (or alternatively could be preconfigured at the UE 3).

The UE 3 may be configured to provide assistance information (UE assistance information) to the network for use by the network in configuring the DRX cycle. The assistance information may be transmitted, for example, from the UE 3 to the base station 5 following an RRC reconfiguration procedure.

Whilst DRX has been described above with reference to discontinuous reception performed by the UE 3, as will be described in more detail later a corresponding procedure for discontinuous reception and/or discontinuous transmission can be performed at the base station 5.

### Wakeup Signal

In a modification of the DRX methods described above, a wake up signal (WUS) may be used. The WUS can be used to indicate, to the UE 3, when the UE 3 is to enter the ON state for reception of a transmission from the base station 5, and when the UE 3 is to remain in the sleep state even during the ON periods of the DRX cycle. The UE 3 may be configured to remain in the DRX inactive mode during an ON period of the DRX cycle if the UE 3 has not received the WUS indicating that the UE is to enter the ON state for that period (or if the UE 3 receives an implicit or explicit indication from the base station 5 that indicates that the UE 3 is to remain in the sleep state during a particular time period of the DRX cycle). Alternatively, the UE 3 may be configured to enter the ON state during the ON period of the DRX cycle if the UE 3 does not receive the WUS, any may be configured to remain in the DRX inactive state during the ON period only if the UE 3 receives an explicit or implicit indication to remaining in the DRX inactive state during that period from the base station 5. The UE 3 may receive, from the base station 5, an indication in downlink control information (DCI) that the UE 3 is to operate in the sleep mode in an ON period of a DRX cycle. Similarly, the UE 3 may receive, from that base station 5, an indication in downlink control information (DCI) that the UE 3 is to ‘wake up’ and enter the DRX active state in a subsequent ON period of the DRX cycle, for reception of a transmission from the base station 5 during the ON period. The WUS can therefore advantageously be used to prevent the UE 3 from entering the DRX active state during an ON period of the DRX cycle when the UE 3 is not required to receive a transmission from the base station 5 during that period, thereby reducing the energy consumption of the UE 3.

The UE 3 may be configured to indicate to the network (e.g. via a transmission to the base station 5) whether the UE 3 supports the use of WUS. The UE 3 may include the indication in any suitable UE capability information transmitted from the UE 3 to the base station 5. The UE 3 may similarly be configured to indicate to the network whether the UE 3 supports DRX.

As will be described in more detail later, the UE 3 may monitor for the WUS based on a WUS configuration provided in system information (SI). The WUS configuration may include a time-offset between the end of the WUS and the start of the first paging occasion (PO) that the UE 3 is to monitor, for reception of a transmission from the base station 5. The time offset may be, for example, a number of subframes. The paging occasion is a subframe where there may be a paging radio network temporary identifier (P-RNTI) transmitted on PDCCH or machine type communication PDCCH (MPDCCH).

The UE 3 may also be configured for reception of a group WUS (GWUS). The UE 3 may monitor for the GWUS using corresponding GWUS parameters provided to the UE 3 in system information. Upon detecting the GWUS or the WUS, the UE 3 enters the DRX active state in the corresponding period of the DRX cycle based on the GWUS or WUS as described above.

### Uplink WUS

The WUS has been described above with reference to a wakeup signal that is transmitted from the base station 5 to the UE 3. This type of WUS may be referred to as a downlink WUS. However, a WUS may be transmitted from the UE 3 to the base station 5 in order to ‘wake up’ the base station 5 (e.g. to request a transition of a cell from no or reduced transmission/reception activity to an active transmission or reception of a channel/signal). This type of WUS may be referred to as an uplink WUS. The uplink WUS may be transmitted from the UE 3 to the base station 5 in order to trigger or request, for example, the transmission of SSB, SIB1 and/or reference signals by the base station 5. For example, the base station 5 may be configured to perform discontinuous transmission or reception according as described above with reference to the UE 3, and the uplink WUS may be used to request or trigger the transmission or reception of a signal that would not normally be transmitted/received by the base station 5 during the discontinuous transmission/reception.

The uplink WUS may be for triggering (or controlling, or requesting) a change in SSB transmission by the base station 5. For example, the base station 5 may be configured for SSB/SIB1-less operation for intra-band carrier aggregation, in which the UE 3 is configured to retrieve system information (and perform synchronisation based on) another intra-band cell that transmits SSB and SIB1. It will be appreciated that a UE 3 may be configured with multiple carriers, and that in carrier aggregation (CA) a set of allowed band combinations are specified. The carrier aggregation may be inter-band, may be contiguous intra-band, or may be non-contiguous intra-band.

A carrier aggregation method may include the operation of a primary cell (Pcell) and a secondary cell (Scell) by one or more base stations 5. An intra-band SSB-less Scell may be configured in the communication system. Inter-band carrier aggregation with SSB-less carriers may be supported, in which case synchronisation may be achieved using other cells that are configured for SSB transmission. Activation of inter-band SSB-less Scell operation may include a mechanism for the UE 3 or the base station 5 to trigger normal SSB transmission and/or reference signal transmission by the base station 5 (e.g. via an uplink triggering signal). The uplink triggering signal may be received at either the inter-band SSB-less cell, or at another carrier or cell. RACH transmission may also be supported in the SSB-less Scell. Dynamic Pcell switching may be configured in the communication system, in which a common Pcell is dynamically indicated for a group of UEs 3. The SSB periodicity may be, for example, 150 ms. The UE 3 may be configured to obtain system information from other associated carriers/cells and synchronise using other associated carriers/cells and/or synchronise from one or more signals transmitted in the cell. Transmission of SSBs/SIB1 by the base station 5 may be on-demand (for example, in response to a request from the UE 5). The uplink WUS may be used to request (or trigger) transmission of a particular SSB or SIB by the base station 5.

### Uplink Wakeup Signal and MAC CE

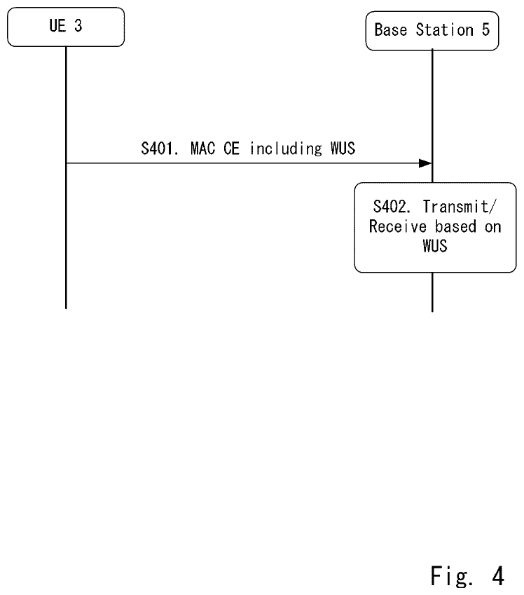

A method of transmitting an uplink WUS using a medium access control (MAC) control element (CE) will now be described with reference to FIG. 4.

As shown in FIG. 4, in step S401, the UE 3 transmits a MAC CE comprising the WUS to the base station 5. In step S402, the base station performs communication based on the received WUS. For example, as described above, the base station 5 my begin transmission of a particular SSB or SIB based on the received WUS, in a time period in which the base station 5 would not normally transmit the SSB or SIB. However, it will be appreciated that the uplink WUS may be used to control, trigger or request any other suitable transmission to or from the base station 5.

Advantageously, the use of the MAC CE provides flexibility in the triggering/requesting of the particular operation of the base station 5. For example, the MAC CE WUS may be used to trigger or request the base station 5 to transmit/receive a specific signal or channel, or request a periodicity change of a signal or channel transmitted by the base station 5. The MAC CE may be used independently to indicate the requested operation of the base station 5, or may alternatively be used in conjunction with additional signalling (for example, a PRACH) to trigger or request the desired operation of the base station 5. A plurality of fields of a single MAC CE may be used to indicate a plurality of corresponding operations to be performed by the base station 5 (e.g. a plurality of corresponding downlink transmissions). Alternatively, a plurality of MAC CEs may be used to indicate a plurality of corresponding operations to be performed by the base station 5 (e.g. a plurality of corresponding downlink transmissions).

Beneficially, the use of the MAC CE to transmit the WUS enables one or more different requests to trigger one or more desired behaviours (e.g. transmissions) of the base station 5, in addition to providing any other information that may be needed in a particular network configuration or deployment scenario. A further advantage of using a MAC CE to carry the UL WUS in a PUSCH is that a hybrid automatic repeat request (HARQ) feedback mechanism can be used. For example, if WUS in a MAC CE is used to request the base station 5 to ‘wake up’ and enter a state in which the base station 5 can receive an UL signal in a particular resource (e.g. a preconfigured resource), HARQ feedback from the UE 3 can be used to confirm that the base station 5 is aware of subsequent UL transmission from the UE 3.

### Further Examples of Uplink Wakeup Signals

Whilst in the above example the uplink WUS has been described as being transmitted using a MAC CE, this need not necessarily be the case. Alternatively, different signals or channels may be used to ‘wake up’ the base station 5 (e.g. to request/trigger transmissions by the base station, or to request/trigger the base station to receive an uplink transmission from the UE 3).

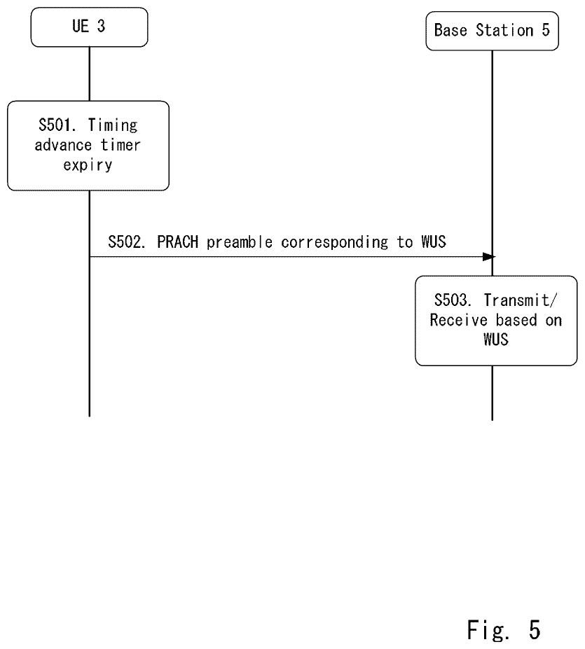

For example, as illustrated in FIG. 5, if UL synchronisation is to be achieved (e.g. a timing advance timer has expired), the UE 3 may transmit a PRACH preamble that acts as the WUS. As shown in FIG. 5, in step S501, a timing advance timer expires at the UE 3. In step S502, the UE 3 transmits a PRACH preamble corresponding to the WUS to the base station 5. Upon reception of the PRACH preamble, the base station 5 is therefore able to determine to perform a particular transmission/reception that is requested or triggered by the UE 3 using the WUS (via the PRACH preamble). In step S503, the base station 5 performs the corresponding transmission and/or reception requested or triggered by the UE 3 using the WUS.

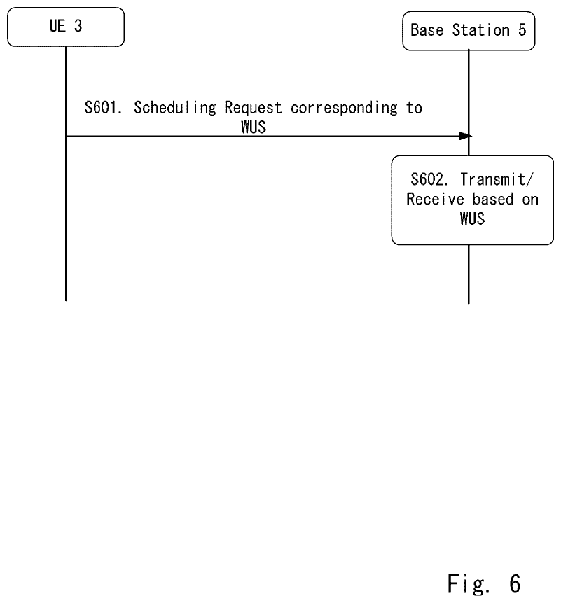

Alternatively, as illustrated in FIG. 6, if the UE 3 is synchronised the UE 3 may transmit a scheduling request comprising the uplink WUS to trigger or request the transmission or reception of a particular signal or channel. As shown in FIG. 6, in step S601, the UE 3 transmits the scheduling request corresponding to the WUS to the base station 5. Upon reception of the scheduling request, the base station 5 is therefore able to determine to perform a particular transmission/reception that is requested or triggered by the UE 3 using the WUS (via the scheduling request). In step S602, the base station 5 performs the corresponding transmission and/or reception requested or triggered by the UE 3 using the WUS.

### Uplink Wakeup Signal Configuration

Configuration of the uplink WUS will now be described. It will be appreciated that the methods of configuring the WUS may be used for any of the uplink WUS mentioned and described above.

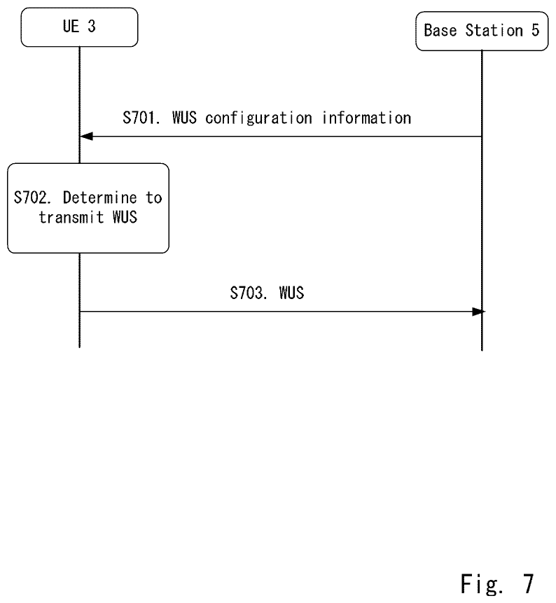

An overview of a method of providing uplink WUS configuration information to the UE 3 is illustrated in FIG. 7. In step S701, WUS configuration information is transmitted to the UE 3. In step S702, the UE 3 determines to transmit the WUS to the base station 5. In step S703, the UE 3 transmits the WUS to the base station based on the WUS configuration information. As described above, the UL WUS may be for triggering or requesting transmission or reception or a particular signal by the base station 5. Whilst in the example of FIG. 7 the configuration for the UL WUS is provided to the UE 3 by the base station 5, the configuration for the UL WUS may alternatively be preconfigured at the UE 3.

The UL WUS configuration information transmitted in step S701 may include a configuration of resources (e.g. time and/or frequency resources) for the UL WUS in a channel specific manner. For example, different communication resources may be configured for different WUS/channels.

The UL WUS configuration information may include a configuration of time and/or frequency resources for UL WUS that are close to (e.g. nearby or contiguous in time or frequency) resources of one or more other downlink or uplink transmissions (e.g. downlink WUS, paging occasions, a UE DRX active period, or CG-PUSCH). In other words, the configuration for the UL WUS may be based on communication resources that are configured for other downlink or uplink transmissions. This beneficially helps to avoid frequent transitions by the UE 3 or the base station 5 between active and inactive states (e.g. DRX inactive and DRX active states of the UE 3). Advantageously, for example, overlap of the resources for the UL WUS with the resources configured for the UE DRX active period further increases the energy efficiency of the system, since the transmission of the UL WUS can be performed in a time period in which the UE 3 was already scheduled to be in the DRX active mode, rather than in a period in which the UE 3 was scheduled to be in the energy saving DRX idle mode.

The configuration for the UL WUS may be based on fixed (e.g. predefined or preconfigured) offsets (time or frequency offsets) relative to resource configurations for other signals or channels. Alternatively, the configuration for the UL WUS may be based on semi-statically or dynamically configured offsets (time or frequency offsets) relative to communication resources configured for other signals or channels. The configuration of the UL WUS may be performed by the base station 5 based on a set of rules (e.g. predefined rules) and using the offsets relative to the resource configurations for the other signals or channels (e.g. the downlink WUS).

When the UL WUS configuration is configured based on resource configurations for other signals or channels, the UL WUS configuration information may include the length or duration of the communication resources and one or more fixed offsets for the UL WUS, to indicate a starting location for the UL WUS relative to the other signals or channels. The other signals or channels may be referred to as the reference resources. Alternatively, the UL WUS configuration information may indicate the starting position for time and/or frequency resource that are indicated in system information (e.g. SIB). The configuration may be cell-specific, or may be group-specific if the corresponding SIB is group or area specific, for example.

The UL WUS configuration information may be indicated to the UE 3 along with signalling for configuration or adaption of other parameters, such as discontinuous transmission or discontinuous reception adaption or configuration parameters. In this case, the UL WUS configuration information may be UE specific or group specific.

The UL WUS configuration information may be indicated to the UE 3 in a group specific manner using L1/L2 signalling. The UL WUS configuration information may be indicated to the UE 3 in a UE specific manner using L1/L2/L3 signalling.

A portion of the UL WUS configuration information may be indicated to the UE 3 in system information (e.g. using SIB), and another portion of the UL WUS configuration information may be indicated to the UE 3 in a group-specific or UE-specific manner.

In a further alternative, a dynamically or semi-statically defined configuration for the UL WUS may be used, that is not based on resources configured for another transmission (e.g. a reference signal).

Whilst in the example shown in FIG. 7 the UL WUS configuration information is illustrated as being transmitted from the base station 5 to a single UE 3, this need not necessarily be the case. The UL WUS configuration information may be transmitted in a cell-specific manner (e.g. using SIB), for example using common resources for UEs 3 in a cell. Alternatively, the UL WUS configuration information may be transmitted in a group-specific manner (e.g. using downlink control information (DCI) or a MAC CE), using common resources configured for a group of UEs 3. In a further alternative, the UL WUS configuration information may be transmitted in a UE-specific manner (e.g. using DCI, MAC CE or RRC signalling). All or a part of the configuration for the UL WUS may be static, semi-static or dynamic. When a plurality of UL WUS are configured (e.g. to trigger/request transmission or reception of corresponding respective signals by the base station 5), each of the UL WUS need not necessarily be configured in the same manner. For example, UL WUS configuration information for one of the UL WUS may be configured using UE-specific signalling, whereas UL WUS configuration information for another of the UL WUS may be provided using cell-specific signalling.

The UL WUS configuration information transmitted in step S701 may be indicated either implicitly or explicitly by the base station 5 (or alternatively in a hybrid explicit-implicit manner). When the UL WUS configuration information transmitted in step S701 is indicated in an explicit-implicit manner, part of the UL WUS configuration information may be provided in system information or any other suitable group-specific or UE-specific L1/L2/L3 signalling, and the resource configuration for the UL WUS may be determined by the UE 3 based on a predefined rule.

The UL WUS configuration information may be transmitted using layer 1 (L1)/layer 2 (L2)/layer 3 (L3) signalling. The information may be transmitted with, or separately from, configuration or adaption information for other signals/channels, either on the energy saving carrier (e.g. utilising DRX) or a different carrier. For example, the UL WUS configuration information may be transmitted using a neighbouring carrier, or using an anchor carrier (the anchor carrier may be configured for additional transmission/reception compared to a corresponding energy-saving carrier).

### User Equipment

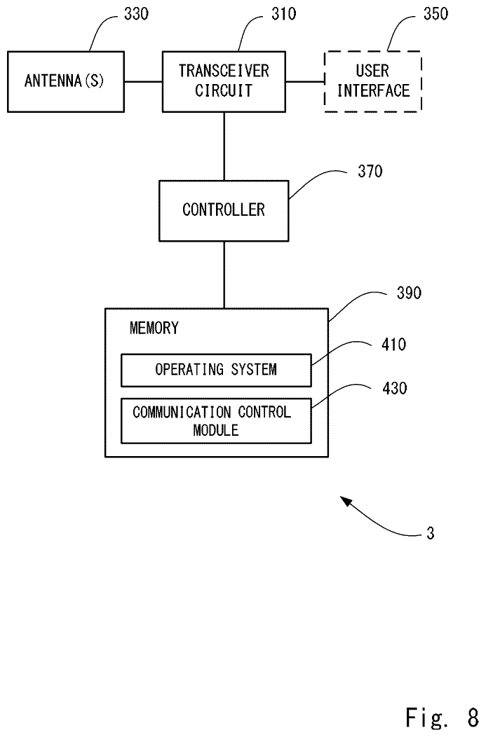

FIG. 8 is a schematic block diagram illustrating the main components of a UE 3 as shown in FIG. 1.

As shown in FIG. 8, the UE 3 has a transceiver circuit 310 that is operable to transmit signals to and to receive signals from a base station 5 via one or more antenna 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the telecommunication network or from a removable data storage device (RMD), for example.

The controller 370 is configured to control overall operation of the UE 3 by, in this example, program instructions or software instructions stored within memory 390. As shown in FIG. 8, these software instructions include, among other things, an operating system 410, and a communication control module 430.

The communication control module 430 is operable to control the communication between the UE 3 and its serving base stations 5 (and other communication devices connected to the base station 5, such as further UEs and/or core network nodes). The communication control module 430 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communication control module 430 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communication control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which bandwidth parts are configured for the UE 3; for determining how uplink transmissions should be encoded; for applying any SBFD specific communication configurations appropriately; and the like. The communication control module 43 may be configured to control communications in accordance with any of the methods described above (for example, to transmit an uplink WUS according to any of the methods described above).

### Base Station

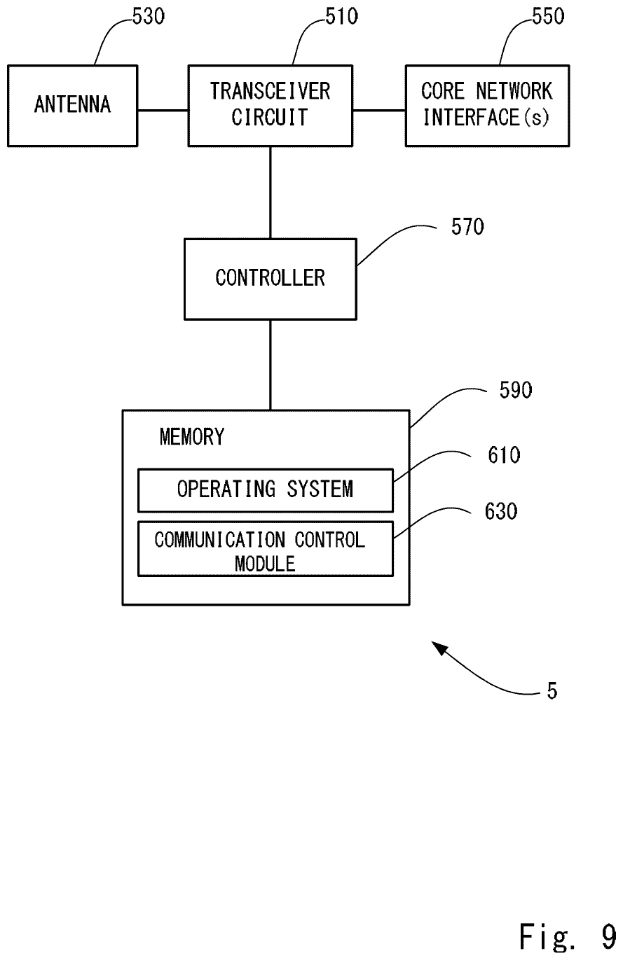

FIG. 9 is a schematic block diagram illustrating the main components of the base station 5 for the communication system 1 shown in FIG. 1. As shown in FIG. 9, the base station 5 has a transceiver circuit 510 for transmitting signals to and for receiving signals from the communication devices (such as UEs 3) via one or more antenna 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communication system 1 or from a removable data storage device (RMD), for example. The controller 570 is configured to control the overall operation of the base station 5 by, in this example, program instructions or software instructions stored within the memory 590.

As shown in FIG. 9, these software instructions include, among other things, an operating system 610 and a communication control module 630.

The communication control module 630 is operable to control the communication between the base station 5 and UEs 3 and other network entities that are connected to the base station 5. The communication control module 630 is configured for the overall control of the reception and decoding of uplink communications, via associated uplink channels (e.g. via a physical uplink control channel (PUCCH), a random access channel (RACH), and/or a physical uplink shared channel (PUSCH)) including both dynamic and semi-static signalling (e.g., SRS). The communication control module 630 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communication control module 630 is responsible for managing full duplex (e.g., SBFD) communication including, where appropriate, the segregation of UL and DL communication via different physical antenna elements. The communication control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring bandwidth parts for the UE 3; for providing related configuration signalling to the UE 3; and the like. The communication control module 43 may be configured to control communications in accordance with any of the methods described above (for example, to receive an uplink WUS and perform corresponding transmission and/or reception of signals to/from the UE 5 as described above).

### Modifications and Alternatives

As those skilled in the art will appreciate, a number of modifications and alternatives can be made to the above embodiments whilst still benefiting from the present disclosure embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the present disclosure, in other applications, for example in systems designed with the inventive features in mind from the outset, these modules may be built into the overall operating system or code and so these modules may not be discernible as discrete entities.

In the above embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communication network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |

Applications, services, and solutions may be an MVNO (Mobile Virtual Network Operator) service, an emergency radio communication system, a PBX (Private Branch exchange) system, a PHS/Digital Cordless Telecommunication system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto. Various other modifications will be apparent to those skilled in the art and will not be described in further detail here.

This application is based upon and claims the benefit of priority from United Kingdom Patent Application No. 2219592.9, filed on Dec. 22, 2022, the disclosure of which is incorporated herein in its entirety by reference.

For example, the whole or part of the exemplary example embodiments disclosed above can be described as, but not limited to, the following supplementary notes.

### (Supplementary Note 1)

A method performed by a user equipment, UE, the method comprising:
transmitting, to an access network node, a wakeup indication for triggering or requesting the access network node to communicate using at least one corresponding communication resource or type of transmission; and
communicating with the access network node using the at least one corresponding communication resource or type of transmission,
wherein the wakeup indication is transmitted to the access network node using at least one of a medium access control, MAC, transmission, a dedicated physical random access channel, PRACH, preamble or a dedicated scheduling request.

### (Supplementary Note 2)

The method according to Supplementary note 1, wherein the wakeup indication is included in a MAC control element, CE, that is transmitted to the access network node.

### (Supplementary Note 3)

The method according to Supplementary note 1 or 2, wherein the wakeup indication indicates at least one of a time or frequency resource for use by the access network node to transmit a corresponding downlink transmission.

### (Supplementary Note 4)

The method according to Supplementary note 3, wherein the corresponding downlink transmission comprises a synchronisation signal block, SSB, or system information block, SIB.

### (Supplementary Note 5)

The method according to any preceding Supplementary note, wherein the wakeup indication indicates at least one of a time or frequency resource for use by the access network node to receive a corresponding uplink transmission from the UE, and the method further comprises transmitting, using the time or frequency resource, the corresponding uplink transmission to the access network node.

### (Supplementary Note 6)

The method according to any preceding Supplementary note, wherein the wakeup indication comprises an indication that the access network node is to change a periodicity of a signal transmitted by the access network node.

### (Supplementary Note 7)

The method according to any preceding Supplementary note, wherein the wakeup indication is transmitted using the MAC transmission and the MAC transmission comprises a plurality of fields, and wherein each field indicates a respective one of the at least one corresponding communication resources.

### (Supplementary Note 8)

The method according to any preceding Supplementary note, wherein the UE transmits a plurality of the wakeup indications to the access network node, and wherein each of the wakeup indications respectively indicates that the access network node is to communicate using at least one corresponding communication resource or type of transmission.

### (Supplementary Note 9)

The method according to any preceding Supplementary note, further comprising:

performing a feedback procedure for the communication with the access network node using the at least one corresponding communication resource.

### (Supplementary Note 10)

The method according to any preceding Supplementary note, further comprising:
receiving, from the access network node, configuration information for transmitting the wakeup indication; and
transmitting the wakeup indication based on the configuration information.

### (Supplementary Note 11)

A method performed by a user equipment, UE, the method comprising:
receiving, from an access network node, configuration information for transmitting a wakeup indication, wherein the wakeup indication is for triggering or requesting the access network node is to communicate using at least one corresponding communication resource or type of transmission;
transmitting the wakeup indication to the access network node based on the configuration information; and
communicating with the access network node using the at least one corresponding communication resource or type of transmission;
wherein the configuration information is based on a communication resource used by the access network node for transmission or reception of a signal other than the wakeup indication.

### (Supplementary Note 12)

The method according to Supplementary note 11, wherein the configuration information includes an indication of a communication resource to use to transmit the wakeup signal to the access network node, wherein the communication resource to use to transmit the wakeup signal to the access network node is based on a communication resource used for a transmission from the access network node to the UE.

### (Supplementary Note 13)

The method according to Supplementary note 11 or 12, wherein the configuration information indicates a communication resource to use to transmit the wakeup signal to the access network node relative to another communication resource.

### (Supplementary Note 14)

The method according to any one of Supplementary notes 11 to 13, wherein the configuration information is based on a discontinuous reception or discontinuous transmission cycle associated with the UE, or is based on a discontinuous reception or discontinuous transmission cycle associated with the access network node.

### (Supplementary Note 15)

The method according to any one of Supplementary notes 11 to 14, wherein the configuration information for transmitting the wakeup indication is transmitted to the UE in at least one of a cell-specific manner, a UE-specific manner, or in a transmission associated with a group of UEs.

### (Supplementary Note 16)

The method according to any one of Supplementary notes 11 to 15, wherein the configuration information includes an explicit indication of a communication resource for transmitting the wakeup indication, and the configuration information includes an indication of a least one of a length or duration of a communication resource to use for transmitting the wakeup indication and a starting position in the time and/or frequency domain to use for transmitting the wakeup indication.

### (Supplementary Note 17)

The method according to any one of Supplementary notes 11 to 16, wherein the configuration information for transmitting the wakeup indication is transmitted to the UE with configuration information for a discontinuous reception or discontinuous transmission procedure performed by the UE.

### (Supplementary Note 18)

A method performed by an access network node, the method comprising:
receiving, from a user equipment, UE, a wakeup indication for triggering or requesting the access network node to communicate using at least one corresponding communication resource or type of transmission; and
communicating with the UE using the at least one corresponding communication resource or type of transmission,
wherein the wakeup indication is received by the access network node using at least one of a medium access control, MAC, transmission, a dedicated physical random access channel, PRACH, preamble or a dedicated scheduling request.

### (Supplementary Note 19)

The method according to Supplementary note 18, wherein
the wakeup indication indicates at least one of a time or frequency resource for use by the access network node to transmit a corresponding downlink transmission, and
the method further comprises transmitting the corresponding downlink transmission.

### (Supplementary Note 20)

The method according to Supplementary note 18 or 19, wherein
the wakeup indication indicates at least one of a time or frequency resource for use by the access network node to receive a corresponding uplink transmission from the UE, and
the method further comprises receiving, using the time or frequency resource, the corresponding uplink transmission from the UE.

### (Supplementary Note 21)

The method according to any one of Supplementary notes 18 to 20, wherein
the wakeup indication comprises an indication that the access network node is to change a periodicity of a signal transmitted by the access network node, and
the method further comprises changing the periodicity of the signal transmitted by the access network node based on the indication that the access network node is to change the periodicity of the signal.

### (Supplementary Note 22)

A method performed by an access network node, the method comprising:
transmitting, to a user equipment, UE, configuration information for use by the UE to transmit a wakeup indication, wherein the wakeup indication is for triggering or requesting the access network node to communicate using at least one corresponding communication resource or type of transmission;
receiving the wakeup indication from the UE, wherein the wakeup indication is transmitted to the access network node by the UE based on the configuration information; and
communicating with the UE using the at least one corresponding communication resource or type of transmission,
wherein the configuration information is based on a communication resource used by the access network node for transmission or reception of a signal other than the wakeup indication.

### (Supplementary Note 23)

A user equipment, UE, comprising:
means for transmitting, to an access network node, a wakeup indication for triggering or requesting the access network node to communicate using at least one corresponding communication resource or type of transmission; and
means for communicating with the access network node using the at least one corresponding communication resource or type of transmission,
wherein the UE is configured to transmit the wakeup indication to the access network node using at least one of a medium access control, MAC, transmission, a dedicated physical random access channel, PRACH, preamble or a dedicated scheduling request.

### (Supplementary Note 24)

A user equipment, UE, comprising:
means for receiving, from an access network node, configuration information for transmitting a wakeup indication, wherein the wakeup indication is for triggering or requesting the access network node to communicate using at least one corresponding communication resource or type of transmission;
means for transmitting the wakeup indication to the access network node based on the configuration information; and
means for communicating with the access network node using the at least one corresponding communication resource or type of transmission,
wherein the configuration information is based on a communication resource used by the access network node for transmission or reception of a signal other than the wakeup indication.

### (Supplementary Note 25)

An access network node comprising:
means for receiving, from a user equipment, UE, a wakeup indication for triggering or requesting the access network node to communicate using at least one corresponding communication resource or type of transmission; and
means communicating with the UE using the at least one corresponding communication resource or type of transmission;
wherein the access network node is configured to receive the wakeup indication using at least one of a medium access control, MAC, transmission, a dedicated physical random access channel, PRACH, preamble or a dedicated scheduling request.

### (Supplementary Note 26)

An access network node comprising:
means for transmitting, to a user equipment, UE, configuration information for use by the UE to transmit a wakeup indication, wherein the wakeup indication is for triggering or requesting the access network node is to communicate using at least one corresponding communication resource or type of transmission;
means for receiving the wakeup indication from the UE, wherein the wakeup indication is transmitted to the access network node by the UE based on the configuration information; and
means for communicating with the UE using the at least one corresponding communication resource or type of transmission,
wherein the configuration information is based on a communication resource used by the access network node for transmission or reception of a signal other than the wakeup indication.

### REFERENCE SIGNS LIST

1 communication system
3 user equipment
5 radio access network node
7 core network
9 cell
310 transceiver circuit
330 antenna
350 user interface
370 controller
390 memory
410 operating system
5 430 communication control module
510 transceiver circuit
530 antenna
550 core network interface
570 controller
10 590 memory
610 operating system
630 communication control module

What is claimed is:

19. A method performed by a mobile device, the method comprising:
transmitting, to an access network node in a network energy saving mode, a wakeup signal for requesting the access network node to transmit at least one of a synchronization signal/physical broadcast channel (PBCH) block (SSB), a system information block 1 (SIB1) or at least one reference signal from at least one of the access network node, at least one cell of the access network node, or at least one transmission/reception point (TRP) coupled to the access network node; and
communicating with the access network node based on the requesting,
wherein the wakeup signal is transmitted using a dedicated physical random access channel (PRACH) preamble.

20. The method according to claim 19, wherein
the wakeup signal is transmitted based on at least one of:
an energy saving technique; or
whether the mobile device is synchronized with the access network node.

21. The method according to claim 19, further comprising:
receiving, from the access network node, configuration information for transmitting the wakeup signal; and
transmitting the wakeup signal based on the configuration information.

22. The method according to claim 21, wherein
the configuration information indicates a resource to use to transmit the wakeup signal to the access network node, and
the resource corresponds to a resource used for another transmission or reception of a signal or channel.

23. The method according to claim 22, wherein
the resource is relative to another resource for the another transmission or reception.

24. The method according to claim 23, wherein
the configuration information indicates an offset relative to the another resource for the another transmission or reception.

25. The method according to claim 24, wherein
the offset is at least one of: a fixed offset, a semi-static offset, or a dynamic offset.

26. The method according to claim 23, wherein
the another resource is for:
a wakeup signal;
a paging occasion;
a mobile device discontinuous reception (DRX) on duration; or
a Configured Grant-Physical Uplink Shared Channel (CG-PUSCH).

27. The method according to claim 21, wherein
the configuration information is transmitted in at least one of:
a cell-specific manner;
a mobile device-specific manner; or
a transmission associated with a group of mobile devices.

28. The method according to claim 21, wherein
the configuration information is transmitted in at least one of:
system information;
a Layer 1 signal;
a Layer 2 signal; or
a Layer 3 signal.

29. The method according to claim 21, wherein
the configuration information indicates at least one of:
a length or duration of a resource to use for transmitting the wakeup signal; or
a starting position in a time and/or frequency domain to use for transmitting the wakeup signal.

30. The method according to claim 21, wherein
the configuration information is transmitted with configuration information for a discontinuous reception or discontinuous transmission procedure performed by the mobile device.

31. The method according to claim 19, further comprising:
performing a feedback procedure for the transmitting the at least one of the SSB, the SIB1 or the at least one reference signal.

32. A method performed by an access network node in a network energy saving mode, the method comprising:
receiving, from a mobile device, a wakeup signal for requesting the access network node to transmit at least one of a synchronization signal/physical broadcast channel (PBCH) block (SSB), a system information block 1 (SIB1) or at least one reference signal from at least one of the access network node, at least one cell of the access network node, or at least one transmission/reception point (TRP) coupled to the access network node; and
communicating with the mobile device based on the requesting,
wherein the wakeup signal is received using a dedicated physical random access channel (PRACH) preamble.

33. A mobile device, comprising:
at least one memory storing instructions; and
at least one processor configured to process the instructions to:
transmit, to an access network node in a network energy saving, a wakeup signal for requesting the access network node to transmit at least one of a synchronization signal/physical broadcast channel (PBCH) block (SSB), a system information block 1 (SIB1) or at least one reference signal from at least one of the access network node, at least one cell of the access network node, or at least one transmission/reception point (TRP) coupled to the access network node; and
communicate with the access network node based on the requesting,
wherein the mobile device is configured to transmit the wakeup signal using a dedicated physical random access channel (PRACH) preamble.

34. An access network node in a network energy saving mode, comprising:
at least one memory storing instructions; and
at least one processor configured to process the instructions to:
receive, from a mobile device, a wakeup signal for requesting the access network node to transmit at least one of a synchronization signal/physical broadcast channel (PBCH) block (SSB), a system information block 1 (SIB1) or at least one reference signal from at least one of the access network node, at least one cell of the access network node, or at least one transmission/reception point (TRP) coupled to the access network node; and
communicate with the mobile device based on the requesting,
wherein the access network node is configured to receive the wakeup signal using a dedicated physical random access channel (PRACH) preamble.
